(19) United States
(12) Patent Application Publication
(10) Pub. No.: US 2023/0122992 A1
(43) Pub. Date: Apr. 20, 2023

(54) WIRING MEMBER AND ATTACHMENT STRUCTURE OF WIRING MEMBER

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Kyousyou KOU, Mie (JP); Housei MIZUNO, Mie (JP); Miyu ARAMAKI, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/913,208

(22) PCT Filed: Mar. 8, 2021
(86) PCT No.: PCT/JP2021/008865

§ 371 Date: Sep. 21, 2022

(30) Foreign Application Priority Data
Mar. 26, 2020 (JP) 2020-055957

(51) Int. Cl. H01B 7/40; B60R 16/02; H01B 7/08; H01B 7/18

(52) U.S. Cl. CPC H01B 7/40; B60R 16/0215; H01B 7/08; H01B 7/18

(57) ABSTRACT

A wiring member includes a first wire-like transmission member and a second wire-like transmission member arranged in parallel to each other and a sheet to which the first wire-like transmission member and the second wire-like transmission member are fixed. At least one of the first wire-like transmission member or the second wire-like transmission member includes the plurality of first wire-like transmission members or the plurality of second wire-like transmission members. The sheet includes a first portion to which the first wire-like transmission member is fixed and a second portion to which the second wire-like transmission member is fixed. The first portion is folded back to the second portion, and an edge portion of the first portion and an edge portion of the second portion are fixed to each other at a side opposite to a folded portion where the sheet is folded back.

### TECHNICAL FIELD

The present disclosure relates to a wiring member and an attachment structure of the wiring member.

### BACKGROUND ART

Patent Document 1 discloses a wire harness in which an electrical wire is welded to a functional exterior member formed into a sheet-like shape.

### PRIOR ART DOCUMENTS

### Patent Documents

Patent Document 1: Japanese Patent Application Laid-Open No. 2018-137208

### SUMMARY

### Problem to be Solved by the Invention

Electrical wires are desired to be simply stacked.

Accordingly, an object is to provide a technique capable of simply stacking a wire-like transmission member fixed to a sheet.

### Means to Solve the Problem

A wiring member according to the present disclosure is a wiring member including: at least one first wire-like transmission member and at least one second wire-like transmission member arranged in parallel to each other; and a sheet to which the first wire-like transmission member and the second wire-like transmission member are fixed, wherein at least one of the first wire-like transmission member or the second wire-like transmission member includes the plurality of first wire-like transmission members or the plurality of second wire-like transmission members, the sheet includes a first portion to which the first wire-like transmission member is fixed and a second portion to which the second wire-like transmission member is fixed, the first portion is folded back to the second portion, and an edge portion of the first portion and an edge portion of the second portion are fixed to each other at a side opposite to a folded portion where the sheet is folded back.

### Effects of the Invention

According to the present disclosure, the wire-like transmission member fixed to the sheet can be simply stacked.

### BRIEF DESCRIPTION OF DRAWINGS

FIG. 1 is a schematic plan view illustrating a wiring member according to an embodiment 1.

FIG. 2 is a cross-sectional view of the wiring member cut along a II-II line in FIG. 1.

FIG. 3 is a schematic plan view illustrating the wiring member before being folded hack.

FIG. 4 is a cross-sectional view illustrating an attachment structure of the wiring member according to an embodiment 2.

FIG. 5 is an explanation diagram illustrating a manufacture of the attachment structure of the wiring member according to the embodiment 2.

FIG. 6 is a cross-sectional view illustrating a modification example of the wiring member.

### DESCRIPTION OF EMBODIMENT(S)

[Description of Embodiment of Present Disclosure]

Embodiments of the present disclosure are listed and described firstly.

A wiring member according to the present disclosure is as follows.

(1) A wiring member includes: at least one first wire-like transmission member and at least one second wire-like transmission member arranged in parallel to each other, and a sheet to which the first wire-like transmission member and the second wire-like transmission member are fixed, wherein at least one of the first wire-like transmission member or the second wire-like transmission member includes the plurality of first wire-like transmission member's or the plurality of second wire-like transmission members, the sheet includes a first portion to which the first wire-like transmission member is fixed and a second portion to which the second wire-like transmission member is fixed, the first portion is folded back to the second portion, and an edge portion of the first portion and an edge portion of the second portion are fixed to each other at a side opposite to a folded portion where the sheet is folded back. The sheet is fixed to be folded back between the first portion and the second portion, thus the first wire-like transmission member fixed to the first portion and the second wire-like transmission member fixed to the second portion are stacked. Accordingly, the wire-like transmission member fixed to a sheet material can be simply stacked.

(2) it is also applicable that the wiring member according to (1) further includes a third wire-like transmission member arranged in parallel to the first wire-like transmission member and the second wire-like transmission member, wherein the sheet further includes a third portion provided adjacent to the second portion on a side opposite to the first portion, and the third wire-like transmission member is fixed to the third portion. Accordingly, the third wire-like transmission member is disposed without being stacked.

(3) In the wiring member according to (2), the third wire-like transmission member may be branched from the first wire-like transmission member and the second wire-like transmission member on the sheet. The third wire-like transmission member is not stacked on the first wire-like transmission member and the second wire-like transmission member, thus can be simply branched from the first wire-like transmission member and the second wire-like transmission member.

(4) In the wiring member according to any one of (1) to (3), the first wire-like transmission member and the second wire-like transmission member may be fused to the sheet. Accordingly, the first wire-like transmission member and the second wire-like transmission member can be directly fixed to the sheet without an intervention of the other fixing member.

(5) In the wiring member according to any one of (1) to (4), the first wire-like transmission member and the second wire-like transmission member may be surrounded by the first portion and the second portion. Accordingly, the first wire-like transmission member and the second wire-like transmission member are protected by the first portion and the second portion.

(6) In the wiring member according to any one of (1) to (5), the first portion and the second portion may include a radio wave shielding layer. Accordingly, the first portion and the second portion can function as a shielding layer of the first wire-like transmission member and the second wire-like transmission member.

(7) An attachment structure of a with member according to the present disclosure is an attachment structure of a wiring member including: a wiring member including at least one first wire-like transmission member and at least one second wire-like transmission member arranged in parallel to each other and a sheet to which the first wire-like transmission member and the second wire-like transmission member are fixed; and an attachment target to which the wiring member is attached, wherein at least one of the first wire-like transmission member or the second wire-like transmission member includes the plurality of first wire-like transmission members or the plurality of second wire-like transmission members, the sheet includes a first portion to which the first wire-like transmission member is fixed and a second portion to which the second wire-like transmission member is fixed, the attachment target includes a protruding part, the first portion is folded back to the second portion, and the protruding part is inserted into an edge portion of the first portion and an edge portion of the second portion at a side opposite to a folded portion when* the sheet is folded back. The sheet is fixed to be folded back between the first portion and the second portion by the protruding part. Accordingly, the first wire-like transmission member fixed to the first portion and the second wire-like transmission member fixed to the second portion are stacked. Accordingly, the wire-like transmission member fixed to a sheet material can be simply stacked.

[Details of Embodiment of Present Disclosure]

Specific examples of a wiring member and an attachment structure of the wiring member according to the present disclosure are described hereinafter with reference to the drawings. The present disclosure is not limited to these examples, but is indicated by claims, and it is intended that meanings equivalent to claims and all modifications within a scope of claims are included.

[Embodiment 1]

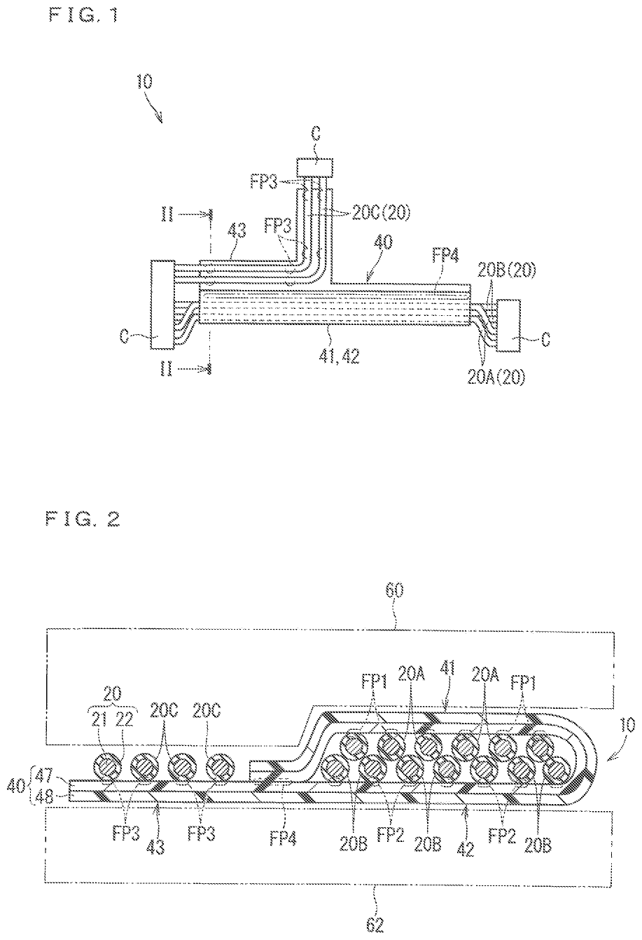

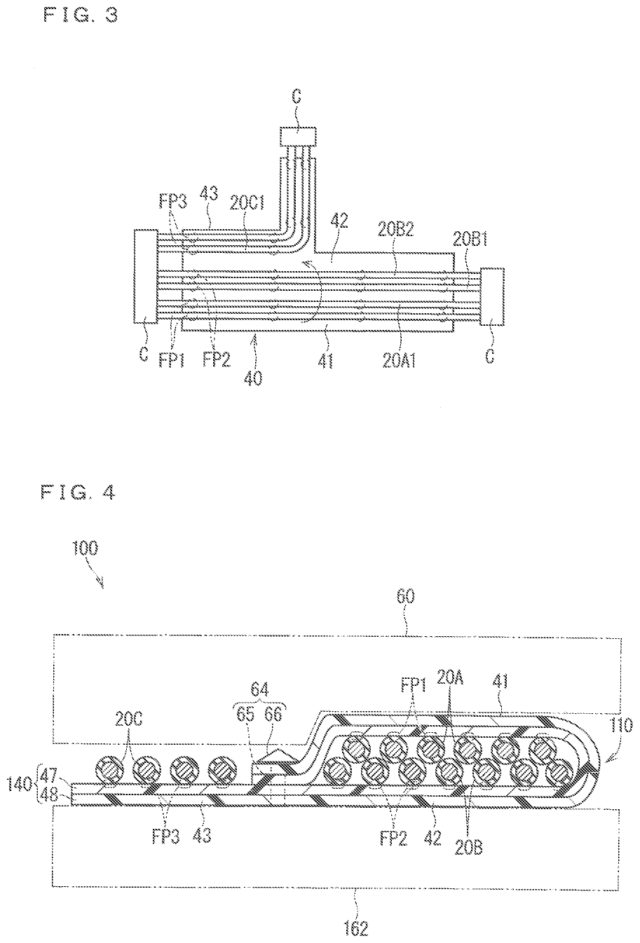

A wiring member according to an embodiment 1 is described hereinafter. FIG. 1 is a schematic plan view illustrating a wiring member 10 according to the embodiment 1. FIG. 2 is a cross-sectional view of the wiring member 10 cut along a II-II line in FIG. 1. FIG. 3 is a schematic plan view illustrating the wiring member 10 before being folded back.

The wiring member 10 includes a plurality of wire-like transmission members 20 and a sheet 40.

The plurality of wire-like transmission members 20 are wire-like members transmitting an electrical power or light, for example. For example, the wire-like transmission member 20 may be a general wire having a core wire and a covering around the core wire, or may also be a shielded wire, an electrical cable, an enamel wire, a nichrome wire, or an optical fiber cable. The wire-like transmission member 20 includes a transmission wire body 21 and a covering layer 22.

The transmission wire body 21 is a portion transmitting an electrical power or light. The transmission wire body 21 corresponds to a conductor core wire in the electrical wire, and corresponds to a core and a clad in an optical fiber cable. The covering layer 22 covers the transmission wire body 21. The covering layer 22 is formed of a resin material extruded around the transmission wire body 21 to cover it, for example. A type of the resin material is not particularly limited, but polyvinyl chloride (PVC), polyethylene (PE), polypropylene (PP), or polyethylene terephthalate (PET) can be adopted, for example.

The wire-like transmission member 20 transmitting the electrical power may be various kinds of signal lines or various kinds of power lines. Some of the wire-like transmission members 20 transmitting the electrical power may be used as an antenna or coil, for example, transmitting or receiving a signal or electrical power to or from a space. The wire-like transmission member 20 may be a single wire-like object or a composite object of a plurality of wire-like objects (a twisted wire and a cable made up of a plurality of wire-like objects covered by a sheath). When the wire-like transmission member 20 is a cable, a sheath is also included in the covering layer 22.

The plurality of wire-like transmission members 20 are assumed to be members connecting components in a vehicle. An end portion of the wire-like transmission member 20 extends from the sheet 40 to be located on an outer side of the sheet 40. An intermediate portion of the wire-like transmission member 20 except for the end portion is disposed on the sheet 40. A connector C, for example, is provided on an end portion of the wire-like transmission member 20. This connector C is connected to a connector provided in the other side component, thus the wire-like transmission member 20 is connected to the other side component. That is to say, the present wiring member 10 is used as the wiring member 10 electrically connecting various types of component in a vehicle, for example (or connecting them so that they can perform optical communication). The end portion of the wire-like transmission member 20 may also be located on the sheet 40. A connector housing of die connector C may be fixed to the sheet 40.

The plurality of wire-like transmission members 20 include a first wire-like transmission member 20A and a second wire-like transmission member 20B. At least one of the first wire-like transmission member 20A or the second wire-like transmission member 20B includes the plurality of first wire-like transmission members 20A or the second wire-like transmission members 20B. Both the plurality of first wire-like transmission member,; 20A and the plurality of second wire-like transmission members 20B are provided herein. Some of die wire-like transmission members 20 are omitted in FIG. 1 and FIG. 3. The first wire-like transmission member 20A and the second wire-like transmission member 20B are arranged in parallel to each other at least in a part of a section on the sheet 40. In the example illustrated in FIG. 1, the parallel section where the first wire-like transmission member 20A and the second wire-like transmission member 20B are arranged in parallel to each other extends over a whole section disposed on the sheet 40. The first wire-like transmission member 20A and the second wire-like transmission member 20B are fixed to the sheet 40 at regions different from each other.

The sheet 40 includes a first portion 41 and a second portion 42. The first wire-like transmission member 20A is fixed to the first portion 41. The second wire-like transmission member 20B is fixed to the second portion 42. The first portion 41 is folded back to the second portion 42 at least in a part of the parallel section of the first wire-like transmission member 20A and the second wire-like transmission member 20B. An edge portion of the first portion 41 and an edge portion of the second portion 42 are fixed to each other at a side opposite to a folded portion where the sheet 40 is folded back.

The first wire-like transmission member 20A and the second wire-like transmission member 20B are surrounded by the first portion 41 and the second portion 42. That is to say, the sheet 40 is folded back so that a surface thereof to which the wire-like transmission member 20 is fixed is directed inward and a surface thereof on a side opposite to the surface to which the wire-like transmission member 20 is fixed is directed outward.

The first wire-like transmission member 20A and the second wire-like transmission member 20B may not be surrounded by the first portion 41 and the second portion 42. That is to say, the sheet 40 may be folded back so that a surface thereof on a side opposite to the surface to which the wire-like transmission member 20 is fixed is directed inward a surface thereof to which the wire-like transmission member 20 is fixed is directed outward. In this case, the first portion 41 and the second portion 42 can wholly have contact with each other. The first portion 41 and the second portion 42 may be wholly fixed to each other.

Herein, the plurality of wire-like transmission members 20 further include a third wire-like transmission member 20C. The number of third wire-like transmission members 20C is preferably at least one, thus one or the plurality of third wire-like transmission members 20C are also applicable. The third wire-like transmission member 20C is fixed to the sheet 40 at a region different from those of the first wire-like transmission member 20A and the second wire-like transmission member 20B. The sheet 40 timber includes the third portion 43. The third portion 43 is provided adjacent to the second portion 42 on a side opposite to the first portion 41. The third wire-like transmission member 20C is fixed to the third portion 43.

The third wire-like transmission member 20C is also arranged in parallel at least in a part of the parallel section of the first wire-like transmission member 20A and the second wire-like transmission member 20B. Herein, the third wire-like transmission member 20C is branched from the first wire-like transmission member 20A and the second wire-like transmission member 20B on the sheet 40. Accordingly, herein, the third wire-like transmission member 20C is arranged in parallel in a part of the parallel section of the first wire-like transmission member 20A and the second wire-like transmission member 20B, and is not arranged in parallel in the other part thereof. Herein, a route of the wire-like transmission member 20 includes a branch portion 24. The branch portion 24 is a portion in which the third wire-like transmission member 20C is branched to extend in a direction different from the first wire-like transmission member 20A and the second wire-like transmission member 20B.

Herein, the sheet 40 is formed into a shape along a route of the wire-like transmission member 20. The sheet 40 includes a portion branched in accordance with a branched route of the wire-like transmission member 20. The sheet 40 may be formed into one large rectangular shape, for example.

A dimension from the folded portion between the first portion 41 and the second portion 42 to the edge portion of the first portion 41 is a width dimension of the first portion 41. A dimension from the folded portion between the first portion 41 and the second portion 42 to the edge portion of the second portion 42 is a width dimension of the second portion 42. A width dimension of the first portion 41 is similar to that of the second portion 42. Thus, when the first portion 41 is in a state of planarly extending, the second portion 42 is also in a state of planarly extending. The width dimension of the first portion 41 may be larger or smaller than that of the second portion 42. In this case, when one of the first portion 41 and the second portion 42 having a smaller width dimension is in a state of planarly extending, an intermediate portion of the other one thereof having a larger width dimension is in a state of being bended (for example, a state of being curved) to be separated from the one thereof having the smaller width dimension.

The first wire-like transmission members 20A are arranged in parallel to each other at intervals. The interval between the first wire-like transmission members 20A is smaller than a diameter of the first wire-like transmission member 20A. The interval between the first wire-like transmission members 20A may be equal to or larger than the diameter of the first wire-like transmission member 20A. The same applies to the second wire-like transmission members 20B and the third wire-like transmission members 20C.

A part of the second wire-like transmission member 20B enters a gap between the first wire-like transmission members 20A in the wiring member 10. A center of the second wire-like transmission member 20B is located between centers of the first wire-like transmission members 20A. A part of the first wire-like transmission member 20A enters a gap between the second wire-like transmission members 20B. The center of the first wire-like transmission member 20A is located between the centers of the second wire-like transmission members 20B. Accordingly, a height of the laminated portion can be kept low. The part of the second wire-like transmission member 20B may not enter the gap between the first wire-like transmission members 20A in the wiring member 10. The part of the first wire-like transmission member 20A may not enter the gap between the second wire-like transmission members 20B.

As illustrated in FIG. 3, a first wire-like transmission member 20A1 and the second wire-like transmission member 20B1 are located in a boundary between the first wire-like transmission member 20A and the second wire-like transmission member 20B. An interval between the first wire-like transmission member 20A1 and the second wire-like transmission member 20B1 is larger than an interval between the first wire-like transmission members 20A and an interval between the second wire-like transmission member 20B in a state before the first portion 41 and the second portion 42 are folded back. The interval between the first wire-like transmission member 20A1 and the second wire-like transmission member 20B1 may be equal to or smaller than the interval between the first wire-like transmission members 20A and the interval between the second wire-like transmission members 20B.

As illustrated in FIG. 3, a second wire-like transmission member 20B2 and a third wire-like transmission member 20C1 are located in a boundary between the second wire-like transmission member 20B and the third wire-like transmission member 20C. The interval between the second wire-like transmission member 20B2 and the third wire-like transmission member 20C1 is larger than the interval between the second wire-like transmission members 20B and the interval between the third wire-like transmission members 20C. The interval between the second wire-like transmission member 20B2 and the third wire-like transmission member 20C1 may be equal to or smaller than the interval between the second wire-like transmission members 20B and the interval between the third wire-like transmission members 20C.

In each drawing, a portion of the sheet 40 where the first portion 41 and the first wire-like transmission member 20A are fixed to each other is indicated as a fixing part FP1. In the similar manner, a portion of the sheet 40 where the second portion 42 and the second wire-like transmission member 20B are fixed to each other is indicated as a fixing part FP2. A portion of the sheet 40 where the third portion 43 and the third wire-like transmission member 20C are fixed to each other is indicated as a fixing part FP3. A portion of the sheet 40 where the first portion 41 and the second portion 42 are fixed to each other is indicated as a fixing part FP4.

The plurality of fixing parts FP1, FP2, and FP3 are provided at intervals along an extension direction of the wire-like transmission member 20. The fixing part FP4 is continuously provided along the extension direction of the wire-like transmission member 20. The fixing parts FP1, FP2, and FP3 may be continuously provided along the extension direction of the wire-like transmission member 20. The plurality of fixing parts FP4 may be provided at intervals along the extension direction of the wire-like transmission member 20.

Herein, the first wire-like transmission member 20A and the second wire-like transmission member 20B are fused to the sheet 40. The third wire-like transmission member 20C is also fused to the sheet 40. The first portion 41 and the second portion 42 are also fused to each other. Accordingly, all of the fixing parts FP1, FP2, F3, and FP4 are the fixing parts.

A means of forming such a fusion state is not particularly limited, however, adoptable are various types of fusion means such as ultrasonic fusion, heating pressurizing fusion, hot air fusion, and high-frequency fusion. When the fusion part is formed by these means, the fusion part is in a state of fusion fixation by those means. Specifically, when the fusion part is formed by ultrasonic fusion, the fusion part is an ultrasonic fusion part, for example.

As illustrated in FIG. 2, the sheet 40 includes a fusion layer 47. Herein, the sheet 40 has a double layer structure of the fusion layer 47 and an additional layer 48. The fusion layer 47 has contact with the wire-like transmission member 20. The fusion layer 47 is fused to the covering layer 22 on an outermost side of the wire-like transmission member 20. The sheet 40 may have a single layer structure, or may also have a three or more layer structure.

One surface of the fusion layer 47 is a surface having contact with the wire-like transmission member 20. The fusion layer 47 includes a resin material, or preferably includes a thermoplastic resin material. The resin material of the fusion layer 47 is softened and fused to a fusion target. A type of the resin material is not particularly limited, however, PVC, PE, PP, and PET, for example, can be adopted. The resin material of the fusion layer 47 is preferably the same as the resin material of the covering layer 22.

The fixing part FP1 is a part where the covering layer 22 of the first wire-like transmission member 20A and the fusion layer 47 are fused to each other. The fixing part FP2 is a part where the covering layer 22 of the second wire-like transmission member 20B and the fusion layer 47 are fused to each oilier. The fixing part FP3 is a part where the covering layer 22 of the third wire-like transmission member 20C and the fusion layer 47 are fused to each other.

A structure of the fusion layer 47 is not particularly limited. For example, the fusion layer 47 may be a sheet having an evenly filled cross-sectional surface (also referred to as a non-foam sheet or a solid sheet, for example). The fusion layer 47 is also considered a foam sheet, for example. The fusion layer 47 is also considered a fibrous material sheet such as a braided cloth, a woven cloth, or a non-woven cloth, for example.

The additional layer 48 is formed of a material different from that of the fusion layer 47, or has a different structure. The additional layer 48 increases a function of the fusion layer 47, or adds a function which the fusion layer 47 does not have to the sheet 40. A material constituting the additional layer 48 is a material described for the fusion layer 47 described above or metal, for example. A structure of the additional layer 48 may be any of the structure described for the fusion layer 47 described above. One surface of the additional layer 48 is a surface of the sheet 40 directed to a side opposite to the wire-like transmission member 20.

The fusion layer 47 and the additional layer 48 are fixed to each other while the other surface of the fusion layer 47 and the other surface of the additional layer 48 have contact with each other, A fixing state of the fusion layer 47 and the additional layer 48 is not particularly limited, however, fixing by fusion or adhesion is preferable. For example, when at least one of the fusion layer 47 or the additional layer 48 is a sheet having voids in a surface such as a fibrous material sheet or a foam sheet, a resin material or an adhesive agent enters the voids and the layers can be fixed to each other. Such a configuration causes so-called anchor effect, thus the fusion layer 47 and the additional layer 48 are rigidly fixed.

In the description herein, the fusion layer 47 is a solid sheet formed of resin and the additional layer 48 is a fibrous material sheet. In the description herein, the fusion layer 47 and the additional layer 48 are fused to each other. That is to say, the resin of the fusion layer 47 enters between the fibers of the additional layer 48 while having flowability, and is then hardened. Accordingly, a state where the resin of the fusion layer 47 enters between the fibers of the additional layer 48 is maintained, and the fusion layer 47 and the additional layer 48 are rigidly fixed.

The fusion layer 47 and the additional layer 48 are formed to have the same size (the same planar shape). One of the fusion layer 47 and the additional layer 48 may also be formed to be larger than the other one thereof. The fusion layer 47 and the additional layer 48 are wholly fixed at a region where, they have contact with each other. The fusion layer 47 and the additional layer 48 may also be fixed only at a part of a region where they have contact with each other.

The sheet 40 may be a flexible member. For example, the fusion layer 47 is a resin layer having an evenly tilled cross-sectional surface made up of flexible resin such as flexible PVC as a material, the additional layer 48 is a non-woven cloth made up of PET as a material, and the sheet 40 is a flexible member. For example, the sheet 40 may have a plastic property so as to be able to follow bending of the wire-like transmission member 20. It is also applicable that the wiring member 10 can be bended in a thickness direction (bending so that a fold line follows a main surface of the sheet 40) in a portion where the sheet 40 is provided. The sheet 40 may be a member which cannot be curved in the thickness direction. The sheet 40 may be a member which is not broken but can be bended at a time of being bended in the thickness direction. In this case, the folded portion between the first portion 41 and the second portion 42 is bended.

The sheet 40 may be a member which is not broken but can be bended at a time of being bended in the thickness direction. In this case, a hinge portion is preferably provided between the first portion 41 and the second portion 42. The hinge portion may be formed by partially thinning a part of the sheet 40.

The first portion 41 and the second portion 42 are folded back so that the surface of the sheet 40 to which the wire-like transmission member 20 is fixed, that is to say, the fusion layer 47 is directed inward. Thus, the fusion layers 47 have contact with each other in the edge portion of the first portion 41 and the edge portion of the second portion 42. The fusion layer 47 in the first portion 41 and the fusion layer 47 in the second portion 42 are fused to each other to form the fixing part FP4.

The configuration that the fixing parts FP1, FP2, FP3, and FP4 are the fusion parts is not necessary. Any fixing state is applicable as a fixing state of the fixing parts FP1, FP2, FP3, and FP4. For example, the fixing parts FP1, FP2, FP3, and FP4 may be adhesive parts fixed via an intervention member such as an adhesive agent or a double-sided adhesive tape. For example, the fixing parts FP1, FP2, FP3, and FP4 may be sewing parts sewn with a thread.

The fixing parts FP1, FP2, FP3, and FP4 need not have the same fixing state, however, some fixing state may be different from the other fixing state. For example, it is also applicable that the fixing parts FP1, FP2, and FP3 are fusion parts and the fixing part FP4 is an adhesive part.

In the example illustrated in FIG. 2, the first portion 41 and the second portion. 42 are curved at the folded portion. The first portion 41 and the second portion 42 may be bended at the folded portion. It is also applicable that the first portion 41 and the second portion 42 are bended so that a fold line is not left when they are returned to be in a flat state from the folded state. It is also applicable that the first portion 41 and the second portion 42 have a curving tendency so that a fold line is left when they are returned to be in a fiat state from the folded state.

In the example illustrated in FIG. 2, the first portion 41 and the second portion 42 are not fused to each other at the folded portion. The first portion 41 and the second portion 42 may be fused to each other at the folded portion. In this case, the first portion 41 and the second portion 42 are fused at both sides, thus a laminated portion of the first wire-like transmission member 20A and the second wire-like transmission member 20B in the wiring member 10 is easily kept to have a flat shape.

<Effect Etc. of Embodiment 1>

According to the wiring member 10 having the above configuration, the sheet 40 is fixed to be folded back between the first portion 41 and the second portion 42, thus the first wire-like transmission member 20A fixed to the first portion 41 and the second wire-like transmission member 20B fixed to the second portion 42 are stacked. Accordingly, the wire-like transmission member 20 fixed to the sheet 40 can be simply stacked.

The third wire-like transmission member 20C is fixed to the third portion 43. Accordingly, the third wire-like transmission member 20C is disposed without being stacked. The wiring member 10 is provided with a portion where the wire-like transmission member 20 is stacked and a portion where the wire-like transmission member 20 is not stacked. Accordingly, as illustrated in FIG. 2, for example, the wiring member 10 is easily routed in a space having a region with a different interval between routing target members 60 and 62. Specifically, a first region and a second region are arranged side by side between the routing target members 60 and 62. The second region has a smaller interval than the first region. In this case, the laminated portion of the first portion 41 and the second portion 42 in the wiring member 10 is disposed in the first region and the third portion is disposed in the second region. Accordingly, the wiring member 10 is easily routed between the space between the routing target members 60 and 62 while preventing interference with the routing target members 60 and 62 as much as possible.

The third wire-like transmission member 20C is branched from the first wire-like transmission member 20A and the second wire-like transmission member 20B on the sheet 40. The third wire-like transmission member 20C is not stacked on the first wire-like transmission member 20A and the second wire-like transmission member 20B, thus can be simply branched from the first wire-like transmission member 20A and the second wire-like transmission member 20B.

The first wire-like transmission member 20A and the second wire-like transmission member 20B are fused to the sheet 40. Accordingly, the first wire-like transmission member 20A and the second wire-like transmission member 20B can be directly fixed to the sheet 40 without an intervention of the other fixing member. Herein, the third wire-like transmission member 20C and the sheet 40 are also fused to each other. Accordingly, the third wire-like transmission member 20C can also be directly fixed to the sheet 40 without an intervention of the other fixing member. Herein, the first portion 41 and the second portion 42 are also fused to each other. Accordingly, the first portion 41 and the second portion 42 can also be directly fixed to each other without an intervention of the other fixing member.

The first wire-like transmission member 20A and the second wire-like transmission member 20B are surrounded by the first portion 41 and the second portion 42. Accordingly, the first wire-like transmission member 20A and the second wire-like transmission member 20B are protected by the first portion 41 and the second portion 42.

[Embodiment 2]

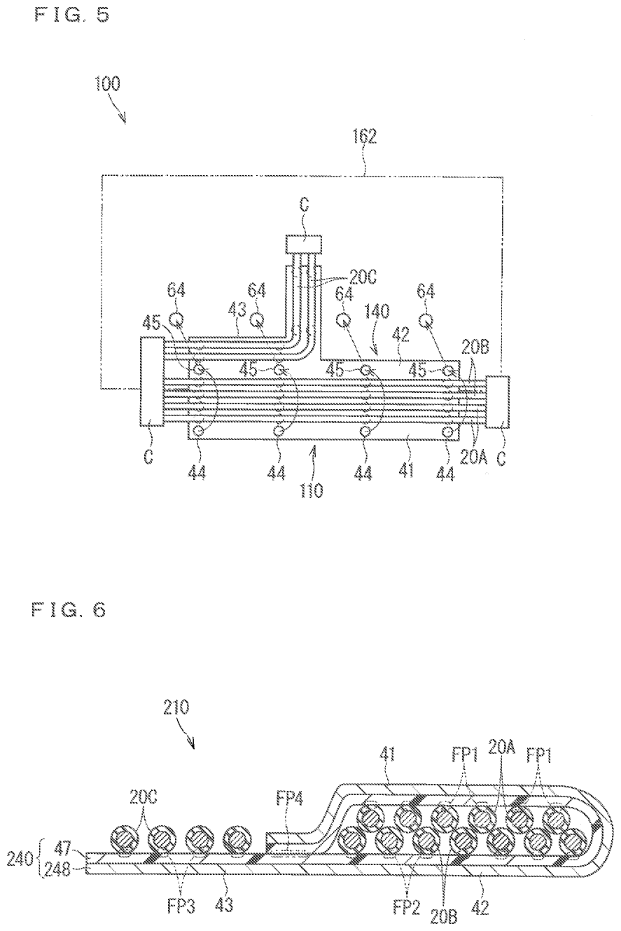

An attachment structure of a wiring member according to an embodiment 2 is described. FIG. 4 is a cross-sectional plan view illustrating the attachment structure of the wiring member according to the embodiment 2. FIG. 5 is an explanation diagram illustrating a manufacture of the attachment structure 100 of the wiring member according to the embodiment 2. In the following description, the same reference numerals are assigned to the similar constituent elements described above, and the description thereof will be omitted.

In the attachment structure 100 of the wiring member, a fixation structure of fixing the first portion 41 and the second portion 42 is different from that in the wiring member 10 described above. The attachment structure 100 of the wiring member includes a wiring member 110 and an attachment target 162.

The wiring member 110 is the same as the wiring member 10 described above except that the first portion 41 and the second portion 42 are not fused to each other and through holes 44 and 45 are formed in the first portion 41 and the second portion 42 of a sheet 140. The through holes 44 and 45 are formed in positions corresponding to each other in the edge portion of the first portion 41 and the edge portion of the second portion 42. Herein, the plurality of through holes 44 are formed in the first portion 41. The plurality of through holes 45 are formed in the second portion 42. The plurality of through holes 44 and 45 are formed in positions where the through holes 44 and 45 corresponding to each other can be overlapped with each other.

The attachment target 162 includes a protruding part 64. The protruding part 64 is inserted into the through holes 44 and 45. The attachment target 162 is one of the routing target members 60 and 62 described above, for example. Described herein is an example that the routing target member 62 is the attachment target 162. Any member in a vehicle is applicable as the attachment target 162, and a panel and a frame, for example, are assumed to be the attachment target 162. The protruding part 64 is assumed to be a locking protrusion provided to protruding on the attachment target 162. The protruding part 64 includes a columnar part 65 and a locking piece 66. The columnar part 65 is formed to have a size similar to the through holes 44 and 45. The columnar part 65 is kept in a state of being inserted into the through holes 44 and 45 while the wiring member 110 is attached to the attachment target 162. The locking piece 66 is formed into a conical shape, for example. The locking piece 66 is formed larger than the columnar part 65 and the through holes 44 and 45. At least one of the locking piece 66 or a peripheral edge part of the through holes 44 and 45 is elastically deformed when the locking piece 66 is inserted into the through holes 44 and 45. Then, at least one of the locking piece 66 or the peripheral edge part of the through holes 44 and 45 is elastically restored after the locking piece 66 is inserted into the through holes 44 and 45. Accordingly, the protruding part 64 is kept in a state of being locked to the peripheral edge part of the through holes 44 and 45.

The first portion 41 is folded back to the second portion 42. The protruding part 64 is inserted into and fixed to the through holes 44 and 45 formed in the edge portion of the first portion 41 on a side opposite to the folded portion and the through holes 44 and 45 formed in the edge portion of the second portion 42.

The protruding part 64 may be a bolt, for example. A bolt may be provided to protrude on the attachment target 162. A tip end of the bolt inserted into the through holes 44 and 45 may be fastened by a nut. A screw hole may be formed in the attachment target 162. A male screw inserted into the through holes 44 and 45 may be fastened in the screw hole.

According to the attachment structure 100 of the wiring member having the above configuration, the sheet 140 is fixed to be folded back between the first portion 41 and the second portion 42 by the protruding part 64. Accordingly, the first wire-like transmission member 20A fixed to the first portion 41 and the second wire-like transmission member 20B fixed to the second portion. 42 are stacked. Accordingly, the wire-like transmission member 20 fixed to the sheet 140 can be simply stacked.

[Modification Example]

FIG. 6 is a cross-sectional view illustrating a modification example of the wiring members 10 and 110.

In a wiring member 210 according to the modification example, a structure of a sheet 240 is different from those of the sheets 40 and 140 in the wiring members 10 and 110. A radio wave shielding layer 248 is provided in the sheet 240 in place of the additional layer 48 in the sheets 40 and 140. Accordingly, the first portion 41 and the second portion 42 can function as a shielding layer of the first wire-like transmission member 20A and the second wire-like transmission member 20B. The radio wave shielding layer 248 may be further stacked between the fusion layer 47 and the additional layer 48 in the sheets 40 and 340 or on an outer surface of the additional layer 48.

The radio wave shielding layer 248 is formed by a conductive material. For example, the radio wave shielding layer 248 is conductive foil such as aluminum foil or copper foil. The conductive foil and the fusion layer 47 can be attached to each other by bonding or fusion, for example. The radio wave shielding layer 248 may be provided with a conductive pattern printed on the other resin layer in the sheet.

The first portion 41 and the second portion 42 are folded back so that the surface of the sheet 40 to which the wire-like transmission member 20 is fixed is directed inward. The first portion 41 and the second portion 42 surround the first wire-like transmission member 20A and the second wire-like transmission member 20B. Thus, the radio wave shielding layer 248 is a shielding layer between the first wire-like transmission member 20A and an outer side and between the second wire-like transmission member 208 and an outer side. The radio wave shielding layer 248 is a shielding layer between the first wire-like transmission member 20A and the third wire-like transmission member 20C and between the second wire-like transmission member 20B and the third wire-like transmission member 20C.

The first portion 41 and the second portion 42 may be folded back so that the surface of the sheet 40 on a side opposite to the surface thereof to which the wire-like transmission member 20 is fixed is directed inward. In this case, the first portion 41 and the second portion 42 intervene between the first wire-like transmission member 20A and the second ware-like transmission member 20B. In this case, the radio wave shielding layer 248 is a shielding layer between the first wire-like transmission member 20A and the second wire-like transmission member 20B.

In addition, the above description, the wiring members 10, 110, and 210 include the third wire-like transmission member 20C, however, this configuration is not necessary. The wiring members 10, 110, and 210 may not include the third wire-like transmission member 20C. Even when the wiring members 10, 110, and 210 include the third wire-like transmission member 20C, the route of the third wire-like transmission member 20C is limited thereto described above. For example, the third wire-like transmission members 20C may be arranged in parallel to the first wire-like transmission member 20A and the second wire-like transmission member 20B over a whole range in the sheet 40.

A fourth portion may be provided on an opposite side of the first portion 41 from the second portion 42. The wire-like transmission member 20 may include a fourth wire-like transmission member fixed to the fourth portion. The fourth portion may be folded back to the first portion 41 and stacked on the first portion 41 and the second portion 42. An edge portion of the fourth portion may be fixed to the folded portion of the first portion 41 and the second portion 42.

The route of the wire-like transmission member 20 is not limited thereto described above. For example, the route of the wire-like transmission members 20 may include a bending portion. The bending portion is a portion where the plurality of wire-like transmission members 20 are bended while being in parallel to each other. The sheet 40 may include a portion bended in accordance with a bending portion of the wire-like transmission member 20. An intersection part where the plurality of wire-like transmission members 20 intersect with each other may be provided on the sheet 40.

The configurations described in the embodiments and modification examples thereof can be appropriately combined as long as they are not contradictory.

### EXPLANATION OF REFERENCE SIGNS

10, 110 210 wiring member

20 wire-like transmission member

20A, 20A1 first wire-like transmission member

20B, 20B1, 20B2 second wire-like transmission member

20C, 20C1 third wire-like transmission member

21 transmission wire body

22 covering layer

24 branch part

40, 140, 240 sheet

41 first portion

42 second portion

43 third portion

44, 45 through hole

47 fusion layer

48 additional layer

248 radio wave shielding layer

60, 62 routing target member

162 attachment target

64 protrusion

65 columnar part

66 locking piece

100 attachment structure

C connector

FP1, FP2, FP3, FP4 fixing part

1. A wiring member, comprising:
at least one first wire-like transmission member and at least one second wire-like transmission member arranged in parallel to each other; and
a sheet to which the first wire-like transmission member and the second wire-like transmission member are fixed, wherein
at least one of the first wire-like transmission member or the second wire-like transmission member includes the plurality of first wire-like transmission members or the plurality of second wire-like transmission members,
the sheet includes a first portion to which the first wire-like transmission member is fixed and a second portion to which the second wire-like transmission member is fixed,
the first portion is folded back to the second portion, and an edge portion of the first portion and an edge portion of the second portion are fixed to each other at a side opposite to a folded portion where the sheet is folded back.

2. The wiring member according to claim 1, further comprising
a third wire-like transmission member arranged in parallel to the first wire-like transmission member and the second wire-like transmission member, wherein
the sheet further includes a third portion provided adjacent to the second portion on a side opposite to the first portion, and the third wire-like transmission member is fixed to the third portion.

3. The wiring member according to claim 2, wherein
the third wire-like transmission member is branched from the first wire-like transmission member and the second wire-like transmission member on the sheet.

4. The wiring member according to claim 1, wherein
the first wire-like transmission member and the second wire-like transmission member are fused to the sheet.

5. The wiring member according to claim 1, wherein
the first wire-like transmission member and the second wire-like transmission member are surrounded by the first portion and the second portion.

6. The wiring member according to claim 1, wherein
the first portion and the second portion include a radio wave shielding layer.

7. An attachment structure of a wiring member, comprising:
a wiring member including at least one first wire-like transmission member and at least one second wire-like transmission member arranged in parallel to each other and a sheet to which the first wire-like transmission member and the second wire-like transmission member are fixed; and
an attachment target to which the wiring member is attached, wherein
at least one of the first wire-like transmission member or the second wire-like transmission member includes the plurality of first wire-like transmission members or the plurality of second wire-like transmission members,
the sheet includes a first portion to which the first wire-like transmission member is fixed and a second portion to which the second wire-like transmission member is fixed,
the attachment target includes a protruding part, and
the first portion is folded back to the second portion, and the protruding part is inserted into an edge portion of the first portion and an edge portion of the second portion at a side opposite to a folded portion where the sheet is folded back.
